(19) United States
(12) Patent Application Publication
(10) Pub. No.: US 2009/0086384 A1
(43) Pub. Date: Apr. 2, 2009

(54) MAGNETO-RESISTANCE EFFECT ELEMENT INCLUDING FERROMAGNETIC LAYER HAVING GRANULAR STRUCTURE

(76) Inventors: Kei Hirata, Tokyo (JP); Satoshi Miura, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/865,885

(22) Filed: Oct. 2, 2007

(51) Int. Cl. G11B 5/33

(52) U.S. Cl. 360/324.2

(57) ABSTRACT

A magneto-resistance effect element of the present invention comprises: a pair of ferromagnetic layers whose magnetization directions change in accordance with an external magnetic field, each of the pair of ferromagnetic layers having a granular structure in which a large number of magnetic grains are distributed within a nonmagnetic matrix material; a conductive nonmagnetic intermediate layer sandwiched between the pair of ferromagnetic layers; and a bias magnetic field applying layer for exerting magnetic force on the pair of ferromagnetic layers. The matrix material in the pair of ferromagnetic layer contains conductive material. Moreover, another magneto-resistance effect element of the present invention includes: a pair of ferromagnetic layers whose magnetization directions change in accordance with an external magnetic field, each of the pair of ferromagnetic layers having a granular structure in which a large number of magnetic grains are distributed within a nonmagnetic matrix material; an insulating nonmagnetic intermediate layer sandwiched between the pair of ferromagnetic layers; and a bias magnetic field applying layer for exerting magnetic force on the pair of ferromagnetic layers. The matrix material in the pair of ferromagnetic layers contains a metallic oxide, and contains the same material as that of the insulating nonmagnetic intermediate layer.

### BACKGROUND OF THE INVENTION

1. Field of the Invention

The present invention relates to a magneto-resistance effect element, and a thin-film magnetic head including such a magneto-resistance effect element.

2. Description of the Related Art

Magnetic disk drives employ a thin-film magnetic head having a magneto-resistance effect element (MR element) for reading magnetic signals. In recent years, efforts have been made to design magnetic disk drives for higher recording densities, and accordingly there are growing demands for thin-film magnetic heads, particularly magneto-resistance effect elements, which satisfy higher-sensitivity and higher-output requirements.

A CIP-GMR (Current in Plane-Giant Magneto-resistance) element which is a giant magneto-resistance effect element having a nonmagnetic intermediate layer between ferromagnetic layers and passing a sensing current in parallel to a layer surface, has been conventionally developed as a reproducing element in a thin-film magnetic head. On the other hand, a magnetic head that uses a TMR (Tunnel Magneto-resistance) element which has an insulation intermediate layer instead of the nonmagnetic intermediate layer and which passes a sensing current perpendicular to a layer surface, has also been developed in order to achieve higher densification. Furthermore, a magnetic head that uses a CPP (Current Perpendicular to Plane)-GMR element which is a GMR element having a nonmagnetic intermediate layer and passing a sensing current perpendicular to the layer surface similar to the TMR element, has also been developed. CPP-GMR element has an advantage of having low resistance in comparison with the TMR element and having higher output in a narrower track width than the CIP-GMR element.

An ordinary GMR element is in the cylindrical shape of a desired size, and is also referred to as a spin valve film (SV film). Such a GMR element has a structure interposing a nonmagnetic intermediate layer between a pinned layer which is a ferromagnetic layer in which the magnetization direction is fixed and a free layer which is a ferromagnetic layer in which the magnetization direction varies according to an external magnetic field. Further, in order to fix the magnetization direction of the pinned layer, an anti-ferromagnetic layer which is exchange-coupled to the pinned layer is provided adjacent to the pinned layer. The upper and lower ends of the GMR element are provided with a cap layer and a buffer layer, respectively. The cap layer, the GMR element, and the buffer layer are interposed between the upper shield layer and the lower shield layer. In the case of the CPP-GMR element, the upper shield layer and the lower shield layer function as an electrode, respectively, and a sensing current flows in a direction orthogonal to the layer surface. Ordinarily, hard bias films are disposed on opposite sides of GMR element in order to apply a bias magnetic field to the free layer to turn free layer into a single magnetic domain.

On the contrary, in U.S. Pat. No. 7,035,062, and “Current-in-Plane GMR Trilayer Head Design for Hard-Disk Drives: Characterization and Extendibility” IEEE Transaction on Magnetics, Vol. 43, No. 2, February 2007, there is proposed a GMR element including a structure in which a nonmagnetic intermediate layer is sandwiched between a pair of ferromagnetic layers whose magnetization directions change in accordance with an external magnetic field, and in which a bias magnetic field applying layer as a ferromagnetic layer is located at the side of the laminated body of the trilayer structure and is disposed at the position opposite to the position where an external magnetic material (e.g., magnetic recording medium) which produces an external magnetic field is disposed. It is assumed that the inventor of this Application refers to the GMR element of this kind as a differential type GMR element. In the case of the differential type GMR element, a pair of ferromagnetic layers are regulated by the bias magnetic field applying layer to a degree such that the magnetization direction is not completely fixed. When an external magnetic body is disposed close to the GMR element, the magnetization directions of respective ferromagnetic layers are changed by the influence of the external magnetic recording medium. In this instance, the resistance value is changed to depend upon whether the magnetic field of the magnetic recording medium is exerted in a direction that cancels the magnetization direction of the ferromagnetic layer regulated by the bias magnetic field applying layer, or is exerted in the same direction as that of the magnetization direction of the ferromagnetic layer regulated by the bias magnetic field applying layer. Accordingly, a change of that resistance value is sensed, thereby making it possible to read magnetic signal of the magnetic recording medium.

In the differential type GMR element, since no pinned layer exists, an anti-ferromagnetic layer adapted to be exchange-coupled to the pinned layer is unnecessary. In general GMR elements, the anti-ferromagnetic layer is relatively thick layer (e.g., thickness of about 7 nm). In the differential type GMR element, this anti-ferromagnetic layer is omitted, thereby making it possible to greatly reduce the entire thickness. Moreover, since a ferromagnetic layer of a single layer, in which magnetization direction is not completely fixed and is changed in accordance with an external magnetic field, is provided in place of the pinned layer which is a multilayer structure (synthetic pinned layer) for enhancing exchange-coupling, the thickness of the entirety of the GMR element can be further reduced. By using such a differential type GMR element, miniaturization, particularly reduction in thickness of the thin-film magnetic head can be realized. Realization of such a thin structure of the thin-film magnetic head leads to a reduction in the gap length between shields to thereby contribute to improvement in resolution in reading of magnetic signal.

Ordinarily, the GMR elements are manufactured by cutting out from wafer 100. However, there may take place unevenness of the magnetic characteristic within wafer 100 from the viewpoint of the characteristic of film forming devices. For example, as shown in FIG. 1, the magnitudes of magnetizations were measured while changing the external magnetic field, at five points (point A to point E) within single wafer 100 to determine magnetization hysteresis loops. Positions of respective graphs indicating the magnetization hysteresis loops approximately indicate positions of the respective points (point A to point E) in wafer 100.

In concrete terms, 90 CoFe film having a thickness of 20 nm was formed on a Si substrate to measure the magnitudes of magnetizations when an external magnetic field was changed at five points within wafer 100 by using MH loop tracer utilizing the Kerr effect. As a result, it was found that the magnetization hysteresis loops at respective points within the wafer were not uniform. In particular, in FIG. 1, it is clear that the magnetization hysteresis loop in the direction of the easy magnetization axis at point A and the magnetization hysteresis loop in the direction of the easy magnetization axis at point B are different from each other. It is to be noted that in this example, since the difference between curves that each indicate a change in the magnetization state, with respect to a change of the magnetic field at the times when the magnetic field in the direction of the easy magnetization axis increases and decreases, is significantly large at point B, this is not preferable. On the other hand, since the difference between curves that each indicate a change in the magnetization state, with respect to a change of the magnetic field at the times when the magnetic field in the direction of the easy magnetization axis increases and decreases, is small at point A, it can be said that the magnetic characteristic which is more preferable as compared to that at point B is exhibited at point A.

Further, the averages and the standard deviations of coercive forces in the direction of the easy magnetization axis, the averages of coercive forces in the direction of the difficult magnetization axis, and the magnitudes of anisotropic magnetic fields at five points within wafer 100 shown in FIG. 1 were calculated. The results are as follows.

Average value of coercive forces in the direction of the easy magnetization axis: 252.3 [A/m] (3.17 [Oe])

Standard deviation of coercive forces in the direction of the easy magnetization axis: 95.5 [A/m] (1.20 [Oe])

Average value of coercive forces in the direction of the difficult magnetization axis: 95.5 [A/m] (1-20 [Oe])

Average value of anisotropic magnetic fields: 1186 [A/m] (14.9 [Oe])

As stated above, unevenness of the magnetic characteristics takes place at plural points within a single wafer. The main cause is that the diameters of magnetic grains of the ferromagnetic layer are not uniform, and that exchange-coupling between magnetic grains is strong. Ordinarily, in order to increase the production efficiency, a large number of GMR elements are fabricated from a large wafer. Further, it is extremely difficult to allow the magnetic characterstics to be uniform over the entire surface of a large wafer. In the case where a large number of GMR elements are manufactured within a single wafer thereafter to cut off the GMR elements to use them, there is high possibility that the magnetic characteristics will be different for every individual GMR element. As a result, there are instances where GMR elements which cannot obtain the desired magneto-resistance effect may be manufactured, leading to bad yield.

In particular, since the differential type CPP-GMR element structurally obtains a magneto-resistance effect by a balance between the magnetic characteristics of a pair of ferromagnetic layers, when the magnetic characteristic varies depending upon positions within a wafer, as described above, the disadvantage in which a desired magneto-resistance effect cannot be obtained becomes conspicuous.

In addition, although not described in detail, also in the TMR element, similarly to the GMR element there exists the drawback that a desired magneto-resistance effect cannot be obtained resulting from the fact that magnetic characteristics within a single wafer are not uniform as stated above.

### SUMMARY OF THE INVENTION

An object of the present invention is to provide a magneto-resistance effect element capable of shortening the gap length between shields to improve resolution in the magnetic signal reading operation, and capable of suppressing unevenness of the magnetic characteristic so that a desired magnetic characteristic can be securely obtained; and a thin-film magnetic head including such a magneto-resistance effect element.

A magneto-resistance effect element of the present invention comprises: a pair of ferromagnetic layers whose magnetization directions change in accordance with an external magnetic field, each of the ferromagnetic layers having a granular structure in which a large number of magnetic grains are distributed within a nonmagnetic matrix material; a nonmagnetic intermediate layer sandwiched between the pair of ferromagnetic layers; and a bias magnetic field applying layer for exerting magnetic force on the pair of ferromagnetic layers.

The nonmagnetic intermediate layer may be a conductive nonmagnetic intermediate layer. In that case, it is preferable that the matrix material in the pair of ferromagnetic layer contain a conductive material.

Alternatively, the nonmagnetic intermediate layer may be an insulating nonmagnetic intermediate layer. In that case, it is preferable that the matrix material in the pair of ferromagnetic layers contain metallic oxide, and contain the same material as that of the insulating nonmagnetic intermediate layer.

The bias magnetic field applying layer is located at a side of the pair of ferromagnetic layers and the nonmagnetic intermediate layer, and is disposed on an opposite side to a position where an external magnetic body for producing the external magnetic field is disposed.

In accordance with these configurations, since the anti-ferromagnetic layer and the synthetic pinned layer is unnecessary, a magneto-resistance effect element having a thin structure can be realized. This contributes to improved resolution for sensing a magnetic field. Moreover, by employing the magnetic layer having a granular structure, the diameter of the magnetic grains can be reduced, and its unevenness can be suppressed. For this reason, the magnetic characteristics of the magnetic layer can be improved to a greater degree than in the prior art. Thus, satisfactory magneto-resistance effect elements and satisfactory thin-film magnetic heads can be obtained.

The above-described objects, features and advantages as well as other objects, features and advantages according to the present invention will become apparent from the following description with reference to the attached drawings illustrating exemplary embodiments of the present invention.

### BRIEF DESCRIPTION OF THE DRAWINGS

FIG. 1 is a diagram showing magnetic characteristics at five points within a wafer in which plural GMR elements of prior art are formed;

FIG. 2 is a cross sectional view of a main part of a thin-film magnetic head according to one embodiment of the present invention;

FIG. 3 is a view of a GMR element used in the thin-film magnetic head shown in FIG. 2 as viewed from its surface to face a recording medium;

FIGS. 4 to 6 are schematic views for explaining the principle of a differential type MR element;

FIG. 7 is an enlarged schematic view showing a granular structure of a magnetic layer;

FIG. 8 is a graph showing the magnetic characteristic at one point within a wafer in which plural GMR elements of the present invention are formed;

FIG. 9 is a view of a TMR element used in the thin-film magnetic head shown in FIG. 2 as viewed from its surface to face a recording medium;

FIG. 10 is a plan view of one example of a wafer in which the thin-film magnetic head shown in FIG. 2 is formed;

FIG. 11 is a perspective view of an example of a slider including the thin-film magnetic head shown in FIG. 2;

FIG. 12 is a perspective view of a head gimbal assembly including the slider shown in FIG. 11;

FIG. 13 is an essential part side view of a hard disc drive including the head gimbal assembly shown in FIG. 12; and

FIG. 14 is a plan view of the hard disc drive including the head gimbal assembly shown in FIG. 12.

### DETAILED DESCRIPTION OF THE PREFERRED EMBODIMENTS

Embodiments of the present invention will be described with reference to the attached drawings.

### [Configuration of Thin-Film Magnetic Head]

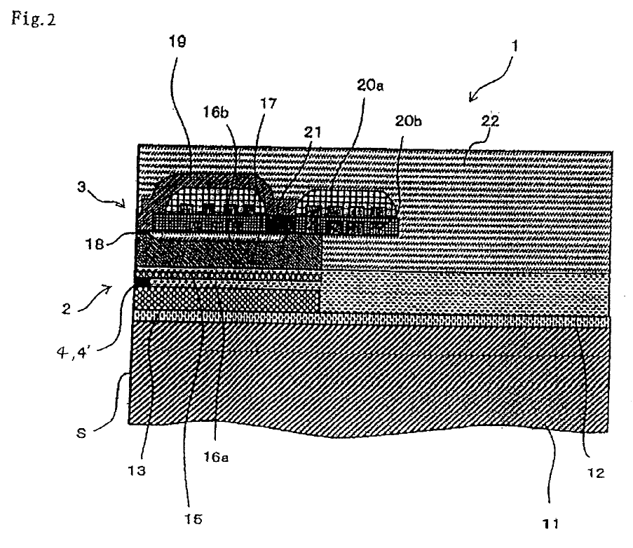

FIG. 2 shows a cross-sectional view of a major portion of a thin-film magnetic head having a magneto-resistance effect element according to the present invention.

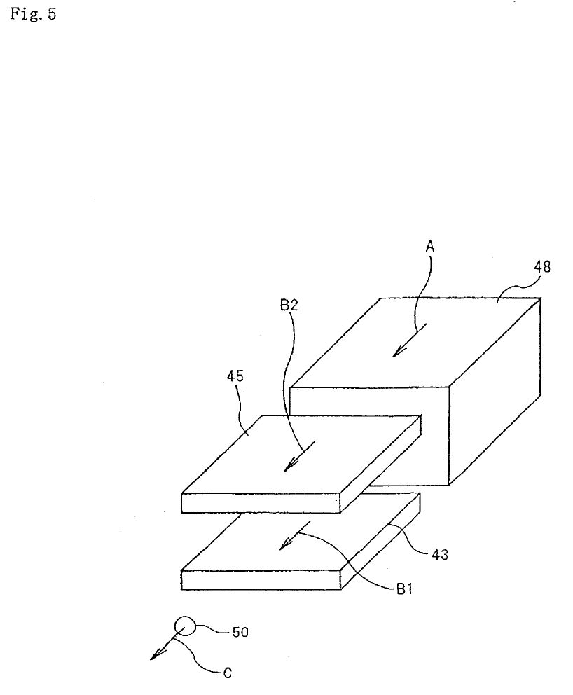

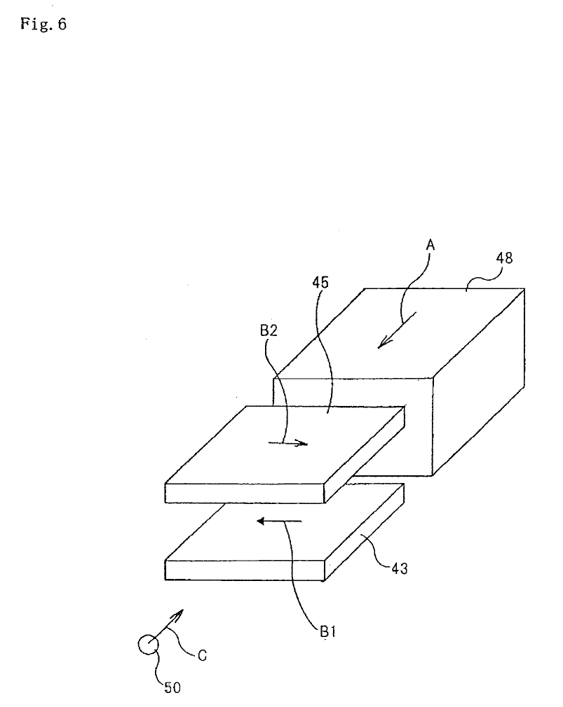

Thin-film magnetic head 1 according to the present embodiment has substrate 11, reproducing unit 2 which reads data from a recording medium 50 (which is schematically illustrated in FIGS. 5, 6) and which is formed on substrate 11, and recording unit 3 for writing data on a recording medium 50 and which is formed on substrate 11. The detailed configuration of reproducing unit 2 and recording unit 3 of this thin-film magnetic head I will be described below. It is to be noted that the recording unit 3 may be perpendicular magnetic recording type for a write operation in a direction perpendicular to a magnetic recording medium.

Substrate 11 is made of Al₂O₃.TiC (AlTiC) that has excellent wear resistance. Base layer 12 made of alumina is disposed on an upper surface of substrate 11, and reproducing unit 2 and recording unit 3 are stacked on base layer 12.

Lower shield layer 13 made of a magnetic material such as Permalloy (NiFe), for example, is disposed on base layer 12. MR element 4, 4′ which is a magneto-resistance effect element is disposed on lower shield layer 13 at an end thereof near surface S to face a recording medium and has an end exposed on surface S to face a recording medium. First upper shield layer 15 made of a magnetic material such as Permalloy, for example, is disposed on MR element 4, 4′. Lower shield layer 13, MR element 4, 4′ and first upper shield layer 15 jointly make up reproducing unit 2. Insulating layer 16a is primarily disposed in a region between lower shield layer 13 and first upper shield layer 15 which is without MR element 4, 4′. It is to be noted that a GMR element according to the present invention is indicated by reference numeral 4, and a TMR element according to the present invention is indicated by reference numeral 4′ here. In thin-film magnetic head 1 shown in FIG. 2, either GMR element 4 or TMR element 4′ may be employed.

Lower magnetic pole layer 17 made of a magnetic material such as Permalloy or CoNiFe is disposed on first upper shield layer 15 with insulating layer 16b interposed therebetween. Lower magnetic pole layer 17 functions as a lower magnetic pole layer of recording unit 3 and also as a second upper shield layer of MR element 4, 4′.

Upper magnetic pole layer 19 is disposed on lower magnetic pole layer 17 which functions as a second upper shield layer, with recording gap layer 18 interposed therebetween, which is made of a nonmagnetic material such as Ru or alumina. Recording gap layer 18 is disposed on lower magnetic pole layer 17 at an end thereof near surface S to face a recording medium and has an end exposed on surface S to face a recording medium. Upper magnetic pole layer 19 is made of a magnetic material such as Permalloy or CoNiFe. Lower magnetic pole layer (second upper shield layer) 17 and upper magnetic pole layer 19 are magnetically connected to each other by connector 21, and they make up a magnetic circuit as a whole.

Coils 20a, 20b made of an electrically conductive material such as copper are disposed as two layers between lower magnetic pole layer 17 and upper magnetic pole layer 19 and also between surface S to face a recording medium and connector 21. Each of coils 20a, 20b serves to supply magnetic fluxes to lower magnetic pole layer 17 and upper magnetic pole layer 19 and has a planar spiral shape surrounding connector 21. Coils 20a, 20b are insulated from the surrounding region by an insulating layer. Though coils 20a, 20b in the two layers are illustrated in this embodiment, they are not limited to the two layers, but may be in one layer or three or more layers.

Overcoat layer 22 is disposed in covering relation to upper magnetic pole layer 19, and protects the structure described above. Overcoat layer 22 is made of an insulating material such as alumina, for example.

### [Configuration of MR Element]

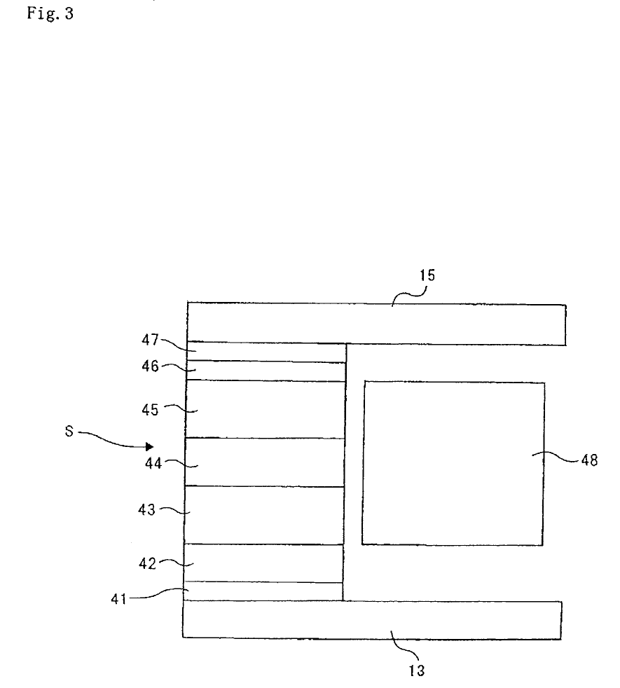

Next, GMR element 4 of the present invention which can be employed in thin-film magnetic head 1 will be described in detail with reference to FIG. 3. TMR element 4′ of the present invention will be described later.

As described above, GMR element 4 is interposed between lower shield layer 13 and upper shield layer 15. GMR element 4 has a structure comprising buffer layer 41, seed layer 42, first ferromagnetic layer 43, nonmagnetic intermediate layer 44, second ferromagnetic layer 45, cap layer 46, and buffer layer 47 which are stacked successively in this order from the side of lower shield layer 13.

Lower shield layer 13 and upper shield layer 15 serve as electrodes, respectively. A sensing current flows in a direction orthogonal to the layer surface through lower shield layer 13 and upper shield layer 15 of GMR element 4. Lower shield layer 13 and upper shield layer 15 comprise NiFe films having a thickness of about 2 μm or less.

One example of materials and thicknesses of the respective layers of MR element 4 is shown in Table 1.

TABLE 1

| | | Film thickness |
|---|---|---|
| | Material | (nm) |
| Buffer layer 47 | Ta | 1 |
| Cap layer 46 | Ru | 1 |
| Second ferromagnetic layer 45 | MgO + 90 CoFe | 3 |
| Nonmagnetic intermediate layer 44 | Cu | 2.5 |
| First ferromagnetic layer 43 | MgO + 30 CoFe | 3 |
| Seed layer 42 | Ru | 2 |
| Buffer layer 41 | Ta | 1 |

Upper and lower buffer layers 41, 47 each comprise Ta having a thickness of 1 nm, for example. Seed layer 42 is made of Ru having a thickness of 2 nm, for example. First ferromagnetic layer 43 is a layer having a thickness of 3 nm and a granular structure in which magnetic grains of 30CoFe are distributed within a nonmagnetic matrix material of MgO, for example. Nonmagnetic intermediate layer 44 is made of a Cu film having a thickness of 2.5 nm, for example. Second ferromagnetic layer 45 is a layer having a thickness of 3 nm and a granular structure in which magnetic grains of 90CoFe are distributed within a nonmagnetic matrix material of MgO. Cap layer 46 is made of a Ru film having a thickness of 1 nm, for example. The detailed structures of first ferromagnetic layer 43 and second ferromagnetic layer 45 will be described later.

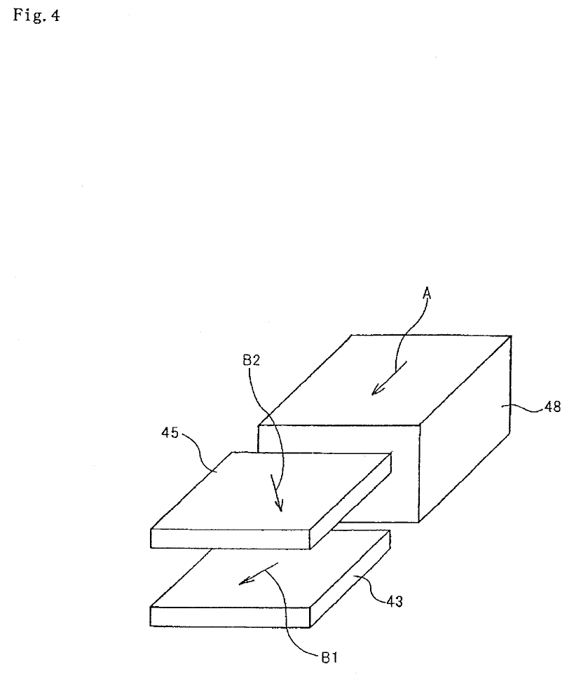

Bias magnetic field applying layer 48 as a ferromagnetic layer is disposed at the inner portion (on the side opposite to surface S to face a recording medium) of MR element 4, i.e., at the side of a pair of ferromagnetic layers 43, 45 and nonmagnetic intermediate layer 44, and at the position opposite to the position where external magnetic body 50 is located to produce an external magnetic field (schematically illustrated in FIGS. 5 and 6). Bias magnetic field applying layer 48 exerts magnetic force on ferromagnetic layers 43, 45 to regulate those magnetization directions to a degree such that they are not completely fixed. For example, as schematically illustrated in FIG. 4, magnetization directions B1, B2 of ferromagnetic layers 43, 45 are directed, to some extent, along direction A of the magnetic force of bias magnetic field applying layer 48. It is to be noted that, in FIGS. 4 to 6, nonmagnetic intermediate layer 44, etc. is omitted, and only ferromagnetic layers 43, 45 and bias magnetic field applying layer 48 are schematically illustrated. Moreover, in FIGS. 5 and 6, external magnetic body 50 such as a magnetic recording medium is schematically illustrated by just a small circle for clarity, although it has a disc-shape much larger than that of GMR element 4 in practice.

When external magnetic body 50 (e.g., a magnetic recording medium) is disposed close to this GMR element 4, GMR element 4 is influenced by magnetic field C of external magnetic body 50 so that magnetization directions B1, B2 of ferromagnetic layers 43, 45 are changed. For example, when external magnetic body 50 applies magnetic field C in the same direction as that of bias magnetic field applying layer 48, as shown in FIG. 5, magnetization directions B1, B2 of ferromagnetic layers 43, 45 become closer to direction A of the magnetic force of the bias magnetic field applying layer. In this case, the resistance value based on the magneto-resistance effect by MR element 4 becomes small. On the other hand, when external magnetic body 50 applies magnetic force C in a direction to cancel the magnetic force exerted by bias magnetic field applying layer 48, as shown in FIG. 6, magnetization directions B1, B2 of ferromagnetic layers 43, 45 are changed to a direction that is nearly at a right angle relative to direction A of the magnetic force of the bias magnetic field applying layer. In this case, the resistance value based on the magneto-resistance effect by this MR element 4 becomes large. As stated above, a read operation of magnetic signal, etc. can be performed on the basis of the resistance value changing in accordance with the direction of the magnetic field of external magnetic body 50.

### [Configuration, Operations, and Effects of Ferromagnetic Layer]

Next, first and second ferromagnetic layers 43, 45, which represent the most characteristic structure of the present embodiment, will be described.

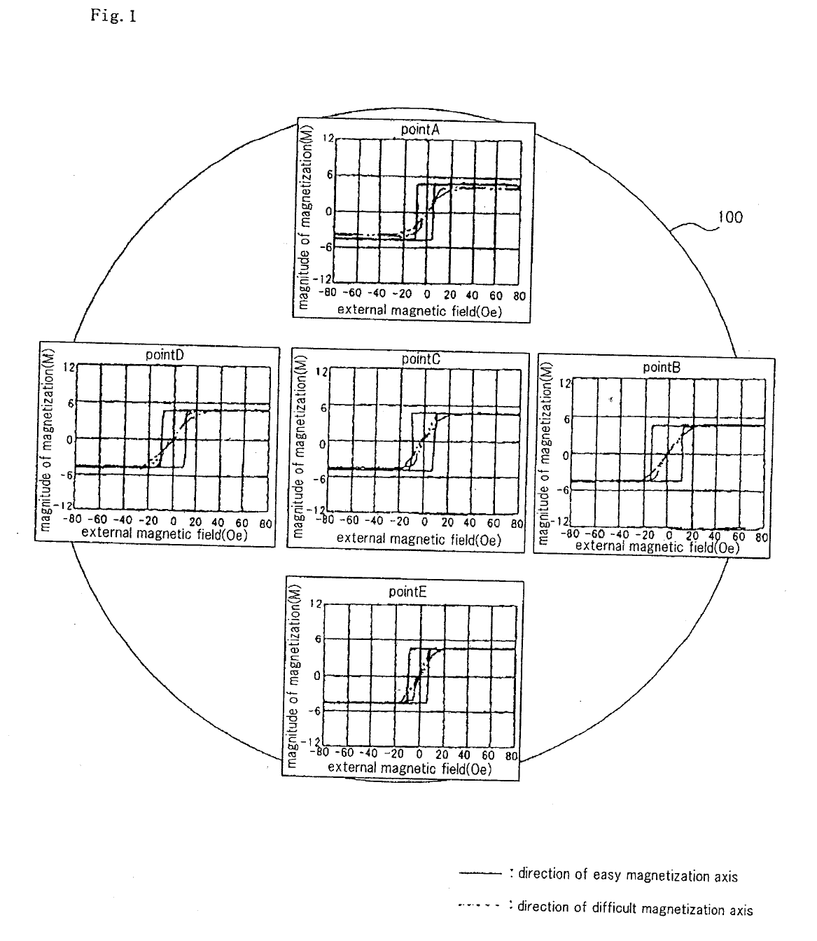

First, the circumstances that led to the realization of the present invention will be described. As stated above, in U.S. Pat. No. 7,035,062 and “Current-in-Plane GMR Trilayer Head Design for Hard-Disk Drives: Characterization and Extendibility”, there is proposed a differential type GMR element of a structure in which a nonmagnetic intermediate layer is sandwiched between a pair of ferromagnetic layers in which each magnetization direction is not fixed and varies in accordance with an external magnetic field, and in which a bias magnetic field applying layer is disposed at the side of the laminated body of the trilayer structure. The GMR element of such a configuration exhibits the advantages that anti-ferromagnetic layer becomes unnecessary and therefore the thickness can be greatly reduced so that miniaturization of the thin-film magnetic head, i.e., improved resolution in the magnetic signal reading operation, can be resultantly made. Moreover, the differential type GMR element exhibits an advantage in which the ferromagnetic layer of a single-layer construction is provided in place of the synthetic pinned layer so that the layer structure is simple. However, there is the drawback that magnetic characteristics are not uniform from the viewpoint of manufacturing such a GMR element. In particular, in the case where plural GMR elements are obtained from a single wafer, there is unevenness of magnetic characteristics within the wafer. For this reason, there is the possibility that plural GMR elements each having different magnetic characteristics may be fabricated from a single wafer (see FIG. 1).

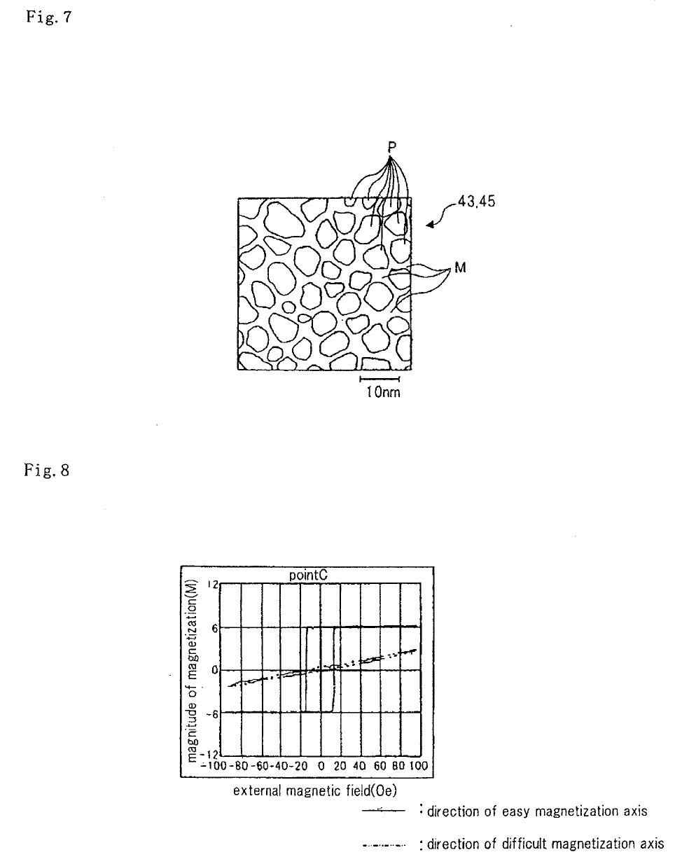

In view of the above, the present inventor has focused attention on the configurations of ferromagnetic layers 43, 45 in order to suppress unevenness of the magnetic characteristics within wafer 100. Thus, the present inventor has attained the configuration of the present invention in which a pair of ferromagnetic layers 43, 45 are caused to be of a granular structure. As schematically illustrated in FIG. 7, the granular structure is a structure in which a large number of grains P are each independently distributed within matrix material M. It is to be noted that general granular structures are illustrated in Japanese Patent Application Laid Open No. H11-238923 and Japanese Patent Application Laid Open No. 2006-157027.

In the configuration shown in Table 1, magnetic grains P of CoFe (30 CoFe or 90 CoFe) are distributed within nonmagnetic matrix material M of MgO.

In accordance with such a granular structure, it is possible to relatively easily control the size of magnetic grains P. Namely, as compared to the continuous film of general alloys, magnetic grains P having a desired size can be prepared. One of the reason may be weakness of exchange-coupling between magnetic grains P. Moreover, in accordance with the granular structure, it is possible to reduce the diameter of magnetic grain P. For example, although not described in detail, in the case where a continuous film of an alloy such as CoFe is formed under general conditions, it is difficult to allow respective grain diameters to be 20 nm or less. As a result, a state will ordinarily occur in which grains having a diameter of about 20 to 40 nm are continuously disposed. On the contrary, although not described in detail, when a target of a magnetic material and a target of a matrix material are simultaneously electrically discharged to form a film having a granular structure by sputtering under general sputtering conditions, magnetic grains P having an average grain diameter of about 10 nm can be formed so that they can be disposed in a distributed manner within matrix material M. In addition, unevenness of grain diameters can be suppressed to a low level.

Next, two kinds of GMR elements in which the size of magnetic grain P was changed were experimentally fabricated according to the present embodiment, and their characteristics were measured. In concrete terms, as a result of the fact that there were fabricated two kinds of GMR elements where the compositions of MgO as matrix material M in ferromagnetic layer of the granular structure are 12 wt % and 8 wt %, the average grain diameters of 90 CoFe which were magnetic grains P were respectively 9.5 nm and 11.2 nm. In this case, controlling the composition of MgO was achieved by changing the composition of the target material. With respect to two kinds of GMR elements, there were determined MR ratios and RA values (area resistances) at 40 points within a wafer. The average values, standard deviations, and CoV (variation coefficient) thereof were respectively determined. The result thereof was shown in Table 2.

TABLE 2

| Matrix material | MgO (12 wt %) | MgO (8 wt %) |
|---|---|---|
| Average grain diameter (nm) of | 9.5 | 11.2 |
| magnetic grains | | |
| Average (%) of MR ratios | 52.1 | 50.5 |
| Standard deviation (%) of MR ratios | 9.5 | 15.2 |
| Variation coefficient (%) of MR | 0.182 | 0.301 |
| ratios | | |
| Average of RA values (Ω · μm²) | 12.3 | 10.2 |
| Standard deviation of RA | 1.5 | 3.5 |
| values (Ω · μm²) | | |
| Variation coefficient of RA | 0.158 | 0.313 |
| values (Ω · μm²) | | |

As seen from Table 2, it is preferable that the average grain diameter of magnetic grains is small because the average of RA values is small and the average of MR ratios is large. Further, in the case where the average grain diameter of magnetic grains is small, standard deviation and variation coefficient of MR ratios and RA values are small. This means that unevenness of characteristics at respective points within a wafer is small. Resultantly, this means that it is possible to stably manufacture, with good accuracy, MR elements having desired characteristics so that the yield is satisfactory. Accordingly, it is preferable that the diameter of magnetic grains be small. For example, it is preferable that the grain diameter be 10 nm or less.

Moreover, there was calculated the average and standard deviation of coercive forces in the direction of an easy magnetization axis, and the average of coercive forces in the direction of a difficult magnetization axis, at five points within wafer 100 in which ferromagnetic layers 43, 45 having the granular structure of the present embodiment were formed. In concrete terms, 90 CoFe film having a thickness of 20 nm was formed on a Si substrate, and its magnitudes of magnetizations was measured by using MH loop tracer utilizing the Kerr effect, while changing an external magnetic field. The results shown in Table 3 are arranged such that they can be compared to data based on the continuous film of an alloy in the above-described prior art.

TABLE 3

| | | Layer of |
|---|---|---|
| | Layer of | granular |
| | continuous film | structure |
| Average value of coercive forces in | 252.3 A/m | 157.6 A/m |
| direction of easy magnetization axis | (3.17 Oe) | (1.98 Oe) |
| Standard deviation of coercive forces in | 95.6 A/m | 51.7 A/m |
| direction of easy magnetization axis | (1.20 Oe) | (0.65 Oe) |
| Average value of coercive forces in | 95.6 A/m | 9.56 A/m |
| direction of difficult magnetization axis | (1.20 Oe) | (0.12 Oe) |
| Magnitude of anisotropic magnetic field | 1186 A/m | 2165 A/m |
| | (14.9 Oe) | (27.2 Oe) |

Referring to Table 3, in the structure of the present embodiment, both the coercive force in the direction of an easy magnetization axis and the coercive force in the direction of a difficult magnetization axis are clearly lowered as compared to those of the related art. This means that the magnetization directions of ferromagnetic layers 43, 45 are apt to be easily changed due to the influence of external magnetic field C of magnetic recording medium 50, etc. Accordingly, it is understood that it is possible to fabricate a magneto-resistance effect element having high sensitivity.

Moreover, in the present embodiment, the standard deviation of coercive forces in the direction of an easy magnetization axis is clearly small as compared to that of the related art configuration. This means that unevenness of coercive forces within wafer 100 is small. Resultantly, it is suggested that unevenness of magnetic characteristics within wafer 100 is small. Namely, although not shown, it is determined that in the case where magnetization hysteresis loops at respective points within wafer 100 are depicted in the present embodiment, they are caused to be uniform as compared to those in FIG. 1.

As stated above, it is determined from data shown in Table 3 that unevenness of magnetic characteristics at plural points within single wafer 100 can be reduced in accordance with the present embodiment. Thus, the yield of manufacturing of GMR element 4 is improved.

Further, in the present embodiment, since exchange-coupling between magnetic grains P is weak as described above, control of the film characteristics including grain diameter, etc. becomes easy by adjusting the film formation conditions. Thus, height of anisotropic magnetic field can be arbitrarily controlled. Accordingly, as shown in Table 3, it is possible to allow the magnitude of the anisotropic magnetic field to be high, according to the present embodiment. In addition, magnetization hysteresis loop at a portion (the same position as point C of FIG. 1) of wafer 100 in which GMR element 4 of the present embodiment is formed is shown in FIG. 8. In FIG. 8, a magnetization saturation point in the direction of a difficult magnetization axis is not shown. Since the magnetization saturation point fails to fall within the graph of FIG. 8 such that it is located on the outside thereof, it can be seen that the magnitude of the external magnetic field in reaching the magnetization saturation point, i.e., the magnitude of the anisotropic magnetic field, is caused to be very high.

When the magnitude of the anisotropic magnetic field is caused to be high in this way, it is possible to shift ferromagnetic resonance of spins of ferromagnetic layers 43, 45 toward the high frequency side. Namely, it is possible to shift spin precession (a movement at the constant angular velocity of rotational axis of rotational body, which is due to torque exerted on an object from the outside) toward the high frequency side. This means that setting can be made such that a phenomenon such as magnetization inversion takes place due to the influence of spin torque at a frequency higher than that under ordinary use. Accordingly, since ferromagnetic resonance hardly takes place at a frequency occurring in ordinary use, it is possible to suppress the influence of spin torque. In “High-Frequency Characterstics of Metal/Native-Oxide Multilayers” described on pp. 2669 to 2671 of “IEEE Transactions on Magnetics, Vol. 39, No. 5” (published on September 2003), and in “Magnetic Properties and GHz Permeability of (FeCo)—(SiO₂) Films with High saturation Magnetization of bcc-FeCo phase” described in the Journal of Magnetics Society of Japan, Vol. 28, No. 7 (published in 2004), it is suggested that the granular structure is employed so that ferromagnetic resonance shifts toward the high frequency side. It is known by persons skilled in the art that (FeCo)—(SiO₂) films have a granular structure.

As described above in detail, when differential type GMR element 4 is fabricated by using ferromagnetic layers 43, 45 having a granular structure, the diameter of magnetic grain P can be reduced, and is permitted to be more uniform. For this reason, there are advantages that uniform magnetic characteristics can be realized, and exchange-coupling between magnetic grains can be reduced to permit the magnitude of the anisotropic magnetic field to be high, thereby acquiring the ability to suppress the influence of the spin torque. In particular, employment of a granular structure in differential type GMR element 4 is an epoch-making invention, and it provides a significant advantage which has been impossible in prior art, in which uniformess of the magnetic characteristics, even with differential type GMR element 4 having a thin structure, can be attained.

Next, materials of ferromagnetic layers 43, 45 having a granular structure will be studied in a practical sense. It is effective to use ferromagnetic layers 43, 45 having a granular structure as mentioned above. In addition, an experiment for finding out the conditions required for permitting the characteristics of GMR element 4 to be further improved was conducted. Here, there were fabricated GMR elements 4 including ferromagnetic layers 43, 45 in which FeCo was used as magnetic grain P, and three kinds of matrix materials M of MgO, Al₂O₃, and Ag were used to determine MR ratios and RA values (area resistances) respectively. The result thereof is shown in Table 4.

TABLE 4

| Matrix material | MR ratio (%) | RA value (Ω · μm²) |
|---|---|---|
| MgO | 4.9 | 3.2 |
| Al₂O₃ | 5.3 | 3.7 |
| Ag | 6.2 | 0.4 |

In general, the performance of the MR element is evaluated by MR ratio=ΔRA/RA value. Accordingly, as the MR ratio becomes high, the output voltage becomes large so that performance is satisfactory. Referring to Table 4, in the case where matrix material M is Ag which is a conductive material, the RA value corresponding to the denominator is smaller as compared to the cases where matrix material M is MgO and Al₂O₃ which are insulating materials. Accordingly, the MR ratio is high and this is preferable.

Moreover, in the case where the RA value is too large, there is the possibility that shot noise proportional to element resistance may be increased so that the SN ratio of a signal obtained from this MR element is lowered. However, as stated above, in the case where matrix material M is Ag which is a conductive material, the RA value is small. For this reason, there is a little possibility that the SN ratio may be lowered due to the influence of shot noise.

In the case where an insulating material is used as matrix material M of ferromagnetic layers 43, 45 having a granular structure, it is considered that since a current concentrates on a part of magnetic grain P so that current density is increased, control of the magnetization state (e.g., control to allow the magnetization directions to be parallel or anti-parallel) is difficult because of the influence of spin torque. Further, it is considered that when matrix material M is an insulating material, the insulating materials scatter conduction electrons (spin conduction electrons) so that the MR ratio is resultantly lowered. On the contrary, it is considered that when a conductive material (Ag, etc.) having a resistance smaller than that of magnetic grain P is used as matrix material M, since no current concentration takes place and since current density is small, the influence of spin torque can be suppressed, and conduction electrons (spin conduction electrons) are scattered to a small degree so that the MR ratio becomes high.

It is to be noted that the materials of magnetic grains P and matrix material M of ferromagnetic layers 43, 45 and the material of nonmagnetic intermediate layer 44 are not limited to the above-mentioned examples, but those materials may be changed. For example, magnetic grain P may be an alloy containing one of Fe, Co, Ni, Cr, Mn, Sb, Si, Al, and Ge. As matrix material M, SiO₂, TiO₂, Al₂O₃, MgO, Ta₂O₅, B, C, Ag, Au, or the like. may be used. It is preferable that matrix material M be a conductive material (Au, Ag, etc.), but making such a selection is not necessarily required. As the material of nonmagnetic intermediate layer 44, Cu, CuZn, CuAl, or the like may be used.

### Other Embodiments

Although the present invention is applied to GMR element 4 in the above-mentioned embodiment, the present invention may be also applied to TMR element 4′. The embodiment relating to TMR element 4′ will be described below. The same reference numerals are respectively attached to parts similar to those of the embodiment relating to GMR element 4, and the explanation will be omitted.

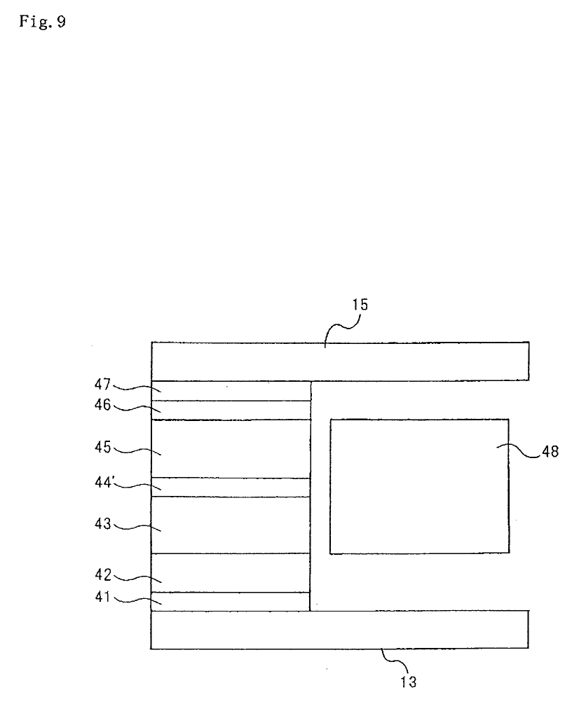

TMR element 4′ of the present embodiment may also be used as reproducing part 2 in the state incorporated in thin-film magnetic head 1 shown in FIG. 2. A practical configuration of TMR element 4′ is interposed between lower shield layer 13 and upper shield layer 15, as shown in FIG. 9. TMR element 4′ has a structure comprising buffer layer 41, seed layer 42, first ferromagnetic layer 43, insulating intermediate layer 44′, second ferromagnetic layer 45, cap layer 46, and buffer layer 47 which are stacked successively in this order from the aide of lower shield layer 13.

Lower shield layer 13 and upper shield layer 15 serve as electrodes, respectively. A sensing current flows in a direction orthogonal to the layer surface through lower shield layer 13 and upper shield layer 15 of TMR element 4′. Lower shield layer 13 and upper shield layer 15 comprise NiFe films having a thickness of about 2 μm or less.

One example of materials and thicknesses of the respective layers of TMR element 4′ is shown in Table 5.

TABLE 5

| | | Film thickness |
|---|---|---|
| | Material | (nm) |
| Buffer layer 47 | Ta | 1 |
| Cap layer 46 | Ru | 1 |
| Second ferromagnetic layer 45 | MgO + 90 CoFe | 3 |
| Insulating intermediate layer 44′ | Mgo | 1 |
| First ferromagnetic layer 43 | MgO + 30 CoFe | 3 |
| Seed layer 42 | Ru | 2 |
| Buffer layer 41 | Ta | 1 |

Upper and lower buffer layers 41, 47 each comprise Ta having a thickness of 1 nm, for example. Seed layer 42 is made of a Ru film having a thickness of 2 nm, for example. First ferromagnetic layer 43 is a layer having a thickness of 3 nm and a granular structure (see FIG. 7) in which magnetic grains P of 30CoFe are distributed within nonmagnetic matrix material M of MgO, for example. Insulating intermediate layer 44′ is made of a MgO film having a thickness of 1 nm, for example. Second ferromagnetic layer 45 is a layer having a thickness of 3 nm and a granular structure in which magnetic grains P of 90CoFe are distributed within matrix material M of MgO. Cap layer 46 is made of a Ru film having a thickness of 1 nm, for example. Bias magnetic field applying layer 48 is disposed at the inner portion (on the side opposite to surface S to face a recording medium) of MR element 4′. The magnetic relationship of bias magnetic field applying layer 48, ferromagnetic layers 43, 45, and external magnetic body 50 (e.g., magnetic recording medium) is similar to the magnetic relationship which has been described with reference to FIGS. 4 to 6.

Also in such differential type TMR element 4′, similarly to GMR element 4 of the above-mentioned embodiment, ferromagnetic layers 43, 45 having a granular structure are used, thereby permitting the diameter of magnetic grain P to be small and to be more uniform. For this reason, there are advantages that uniform magnetic characteristics can be realized, and the influence of spin torque can be suppressed. Since the reason why such advantages can be obtained is the same as the reason which has been described in connection with the embodiment of GMR element 4, description is not given here.

Next, materials of ferromagnetic layers 43, 45 having a granular structure in the case of TMR element 4′ will be studied in a practical sense. It is effective to use ferromagnetic layers 43, 45 having a granular structure as mentioned above. In addition, an experiment for finding out the conditions required for permitting the characteristics of TMR element 4′ to be further improved was conducted. Here, there were fabricated TMR elements 4′ including ferromagnetic layers 43, 45 in which FeCo was used as magnetic grain P, and three kinds of matrix materials M of MgO, Al₂O₃, and Ag were used to determine MR ratios and RA values (area resistances) respectively. The result thereof is shown in Table 6.

TABLE 6

| | | RA value | Standard deviation |
|---|---|---|---|
| Matrix material | MR ratio (%) | (Ω · μm²) | of MR ratio (%) |
| MgO | 52.1 | 12.3 | 4.2 |
| Al₂O₃ | 32.5 | 14.2 | — |
| Ag | 2.1 | 5.6 | — |
| None | 53.2 | 7.5 | 8.2 |

Referring to Table 6, in the case where no matrix material exists within the ferromagnetic layer, i.e., in the case where the ferromagnetic layer is of a configuration which does not have a granular structure, the standard deviation of MR ratios is large. This indicates that unevenness of the magnetic characteristics is large. On the contrary, in the case where the granular structure is employed in the ferromagnetic layer and MgO is used as matrix material M, the MR ratio is substantially the same as that of the configuration which does not have a granular structure, and the standard deviation of the MR ratio was small, namely about one-half of that of the configuration which does not have a granular structure. Accordingly, it is understood that when the granular structure is employed in the ferromagnetic layer, unevenness of magnetic characteristics can be remarkably reduced.

Moreover, in the case where the matrix material of ferromagnetic layers 43, 45 of TMR element 4′ is Ag which is a conductive material, a shunt phenomenon takes place in which a current flows through magnetic grain P of Ag in ferromagnetic layers 43, 45. As a result, the MR ratio is lowered and this is not preferable. The fundamental principle of TMR element 4′ is that the tunnel effect will be caused to take place between both ferromagnetic layers 43, 45 to thereby obtain the magneto-resistance effect. Accordingly, it is preferable that matrix material M within ferromagnetic layers 43, 45 be an insulating material.

Further, when comparison between the case where matrix material M is MgO and the case where matrix material M is Al₂O₃ is made, the case of MgO is preferable because the RA value is smaller and the MR ratio is thus high.

Namely, it is understood that it is preferable that nonmagnetic matrix material M within ferromagnetic layers 43, 45 of TMR element 4′ not be a conductive material, but be an insulating material. Further, it is understood that especially satisfactory characteristics can be obtained in the case where nonmagnetic matrix material M is made of the same material as insulating intermediate layer 44′. Furthermore, in the case where matrix material M and insulating intermediate layer 44′ are made of the same material, there are also advantages that the manufacturing process becomes simple, and manufacturing costs can be suppressed to a low level.

It is to be noted that in the case of TMR element 4′ shown in Table 6, although not shown in a practical sense, since ΔRA is very large, even if the RA value is large to some extent, the MR ratio is larger as compared to the GMR element shown in Table 5 thus acquiring the ability to obtain a sufficient output voltage. Further, since a large output voltage can be obtained in this way in the TMR element, shot noise has little influence on the SN ratio.

It is to be noted that the material of magnetic grain P and matrix material M of ferromagnetic layers 43, 45 and the material of insulating intermediate layer 44′ are not limited to the above-mentioned example, but may be changed. For example, magnetic grain P may be an alloy including containing one of Fe, Co, Ni, Cr, Mn, Sb, Si, Al, and Ge. As matrix material M, SiO₂, TiO₂, Al₂O₃, MgO, Ta₂O₅, B, C, Ag, Au, or the like may be used. As the material of insulating intermediate layer 44′, MgO, Al₂O₃, AlN, ZnO, or the like may be used. Although it is preferable that matrix material M be the same material as insulating intermediate layer 44′, making such a selection is not necessarily required.

[Head Gimbal Assembly and Hard-Disk Drive which Include Thin-Film Magnetic Head]

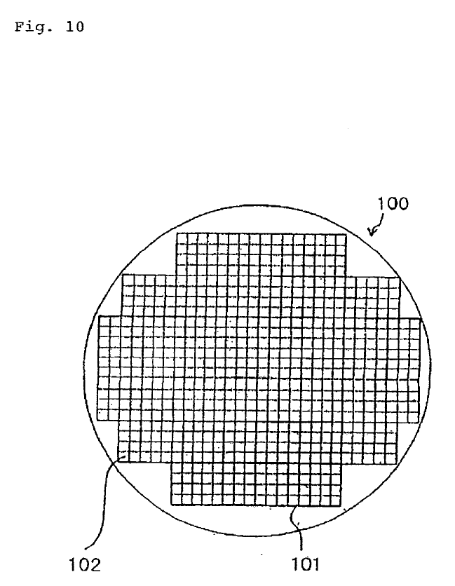

Many thin-film magnetic heads 1 according to the present invention are formed in a single wafer. FIG. 10 shows a diagrammatic plan view of the wafer having many structures (substrates) that includes the thin-film magnetic head shown in FIG. 1 thereon.

Wafer 100 is divided into a plurality of head element aggregates 101 each including a plurality of head elements 102 each serving as a working unit for polishing surface S to face a recording medium of thin-film magnetic head 1 (see FIG. 1). Dicing portions (not shown) are provided between head element aggregates 101 and also provided between head elements 102. Head element 102 is a structure (substrate) including the structure of thin-film magnetic head 1, and becomes thin-film magnetic head 1 after having been subjected to necessary processing such as polishing to form surface S to face a recording medium. The polishing process is carried out generally on a plurality of head elements 102 which has been cut out into a row.

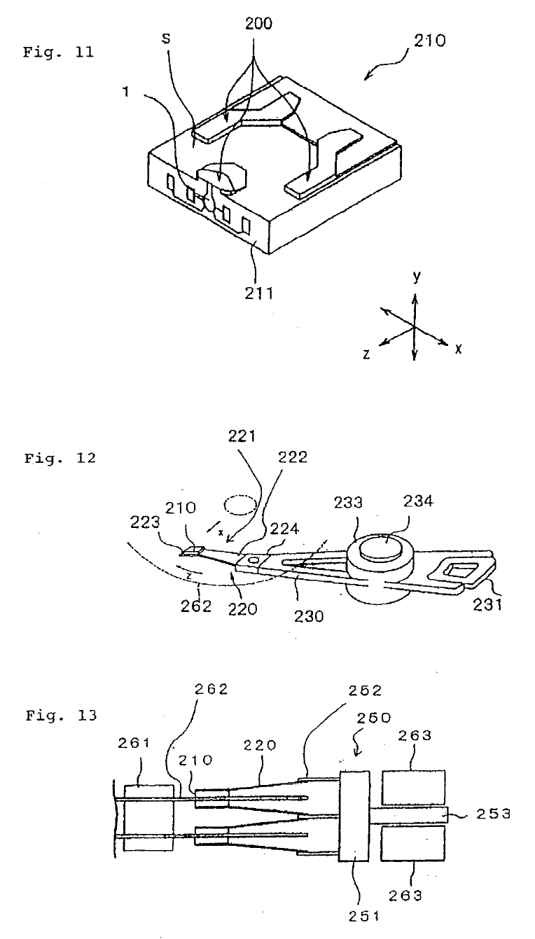

A head gimbal assembly and a hard disk drive having the thin-film magnetic head according to the present invention will be described below. First, slider 210 included in the head gimbal assembly will be described below with reference to FIG. 11. In the hard disk drive, slider 210 is arranged opposite to a hard disk, which is a rotationally-driven disc-shaped recording medium (see FIGS. 5, 6). Slider 210 has thin-film magnetic head 1 obtained from head element 102 (see FIG. 10). Slider 210 has a substantially hexahedral shape in which surface S to face a recording medium is formed into an air bearing surface 200 which is positioned opposite to the hard disk. When the hard disk rotates in z direction in FIG. 11, an air stream passing between the hard disk and slider 210 applies a lifting force to slider 210 downward in a y direction. Slider 210 is lifted from the surface of the hard disk by the lifting force. X directions in FIG. 11 represent a direction transverse to the tracks of the hard disk. At end surface 211 on the outlet side of the airflow of slider 210, are electrode pads to input or output signals to/from reproducing unit 2 and recording unit 3 (see FIG. 1). Surface 211 is the upper end face in FIG. 1.

Head gimbal assembly 220 will be described below with reference to FIG. 12. Head gimbal assembly 220 has slider 210 and suspension 221 by which slider 210 is resiliently supported. Suspension 221 comprises load beam 222 in the form of a leaf spring made of stainless steel, for example, flexure 223 mounted on an end of load beam 222 for giving slider 210 an appropriate degree of freedom, slider 210 being joined to flexure 223, and base plate 224 mounted on the other end of load beam 222. Base plate 224 is mounted on arm 230 of an actuator for moving slider 210 in x directions transverse to the tracks of hard disk 262. The actuator has arm 230 and a voice-coil motor for moving arm 230. A gimbal for keeping slider 210 at a constant attitude is mounted on a portion of flexure 223 where slider 210 is installed.

Head gimbal assembly 220 is mounted on arm 230 of the actuator. A structure wherein head gimbal assembly 220 is mounted on single arm 230 is referred to as a head arm assembly. A structure wherein a carriage has a plurality of arms and head gimbal assembly 220 is mounted on each of the arms is referred to as a head stack assembly.

FIG. 12 shows a head arm assembly by way of example. In the head arm assembly, head gimbal assembly 220 is mounted on an end of arm 230. Coil 231 which is a part of the voice-coil motor is mounted on the other end of arm 230. In the intermediate portion of arm 230, bearing 233 which is attached to shaft 234 for rotatably supporting arm 230 is provided.

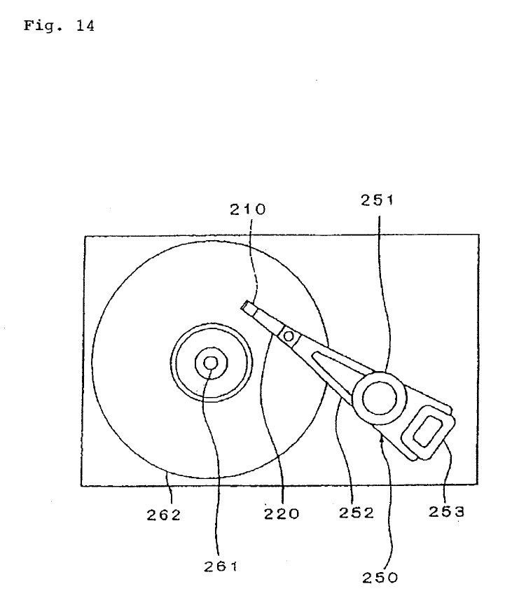

A head stack assembly and a hard disk drive will be described below with reference to FIGS. 13 and 14. FIG. 13 is a view showing a major portion of a hard disk drive, and FIG. 14 is a plan view of the hard disk drive. Head stack assembly 250 has carriage 251 having a plurality of arms 252. A plurality of head gimbal assemblies 220 are attached to a plurality of arms 252 such that head gimbal assemblies 220 are arranged apart from each other in the vertical direction. Coil 253, which constitutes a part of the voice-coil motor, is attached to carriage 251 on the side opposite to arms 252. Head stack assembly 250 is installed in a hard disk drive. The hard disk drive has a plurality of hard disks (magnetic recording media) 262 mounted on spindle motor 261. Two sliders 210 are arranged at positions opposite to each other interposing hard disk 262 therebetween. The voice coil motor has permanent magnets 263 which are arranged in positions opposite to each other interposing coil 253 of head stack assembly 250 therebetween.

Head stack assembly 250, except sliders 210, and the actuator support sliders 210 and position sliders 210 with respect to hard disks 262.

In the hard disk drive, the actuator moves sliders 210 in directions transverse to the tracks of hard disks 262 and position sliders 210 with respect to hard disks 262. Thin-film magnetic heads 1 included in sliders 210 record signal in hard disks 262 through recording unit 3, and reproduce signal recorded in hard disks 262 through reproducing unit 2.

Thin-film magnetic head 1 is not limited to the above embodiments, but may be modified in various ways. For example, though thin-film magnetic head 1 that has a structure wherein reading MR element 4, 4′ is disposed near substrate 11 and writing induction-type electromagnetic transducer is stacked on MR element 4, 4′ has been described in the above embodiments, reading MR element 4, 4′ and the writing induction-type electromagnetic transducer may be switched around. Though a thin-film magnetic head having both an MR element 4, 4′ and an induction-type electromagnetic transducer has been described in the above embodiments, a thin-film magnetic head may have only an MR element 4, 4′.

Although a certain preferred embodiment of the present invention has been shown and described in detail, it should be understood that various changes and modifications may be made without departing from the spirit or scope of the appended claims.

What is claimed is:

1. A magneto-resistance effect element comprising:
a pair of ferromagnetic layers whose magnetization directions change in accordance with an external magnetic field, each of said pair of ferromagnetic layers having a granular structure in which a large number of magnetic grains are distributed within a nonmagnetic matrix material;
a nonmagnetic intermediate layer sandwiched between said pair of ferromagnetic layers; and
a bias magnetic field applying layer for exerting magnetic force on said pair of ferromagnetic layers.

2. The magneto-resistance effect element according to claim 1,
wherein said nonmagnetic intermediate layer is a conductive nonmagnetic intermediate layer.

3. The magneto-resistance effect element according to claim 2,
wherein said matrix material in said pair of ferromagnetic layers contains a conductive material.

4. The magneto-resistance effect element according to claim 1,
wherein said nonmagnetic intermediate layer is an insulating nonmagnetic intermediate layer.

5. The magneto-resistance effect element according to claim 4,
wherein said matrix material in said pair of ferromagnetic layers contains a metallic oxide.

6. The magneto-resistance effect element according to claim 4,
wherein said matrix material in said pair of ferromagnetic layers contains the same material as that of said insulating nonmagnetic intermediate layer.

7. The magneto-resistance effect element according to claim 1,
wherein said bias magnetic field applying layer is located at a side of said pair of ferromagnetic layers and said nonmagnetic intermediate layer, and is disposed on an opposite side to a position where an external magnetic body for producing said external magnetic field is disposed.

8. A thin-film magnetic head including the magneto-resistance effect element according to claim 1.
